(19) United States
(12) Patent Application Publication
(10) Pub. No.: US 2023/0150398 A1
(43) Pub. Date: May 18, 2023

(54) FUEL CELL SYSTEM

(71) Applicants: Hyundai Motor Company, Seoul (KR); Kia Corporation, Seoul (KR)

(72) Inventors: Tae Geun Kim, Seoul (KR); Oh Tak Kwon, Yongin (KR); Jin Hun Lee, Yongin (KR); Hun Woo Park, Namyangju (KR)

(21) Appl. No.: 17/967,593

(22) Filed: Oct. 17, 2022

(30) Foreign Application Priority Data
Nov. 17, 2021 (KR) 10-2021-0158203

(51) Int. Cl. B60L 58/33; H01M 8/04029; H01M 8/04007; H01M 8/04223; H01M 8/04701; H01M 8/04746; H01M 8/04858; H01M 8/04537; H01M 16/00; H01M 10/48; H01M 10/44; B60L 1/02; B60L 58/12; B60L 58/40

(52) U.S. Cl. CPC B60L 58/33; H01M 8/04029; H01M 8/04074; H01M 8/04268; H01M 8/04738; H01M 8/04768; H01M 8/0488; H01M 8/04626; H01M 16/006; H01M 10/48; H01M 10/446; B60L 1/02; B60L 58/12; B60L 58/40; H01M 2250/20; H01M 2220/20

(57) ABSTRACT

Described herein is a fuel cell system that includes a radiator configured to exchange heat with coolant discharged from a fuel cell stack, a coolant supply pump configured to supply the coolant to the fuel cell stack, a COD heater configured to consume electric power generated by the fuel cell stack, a valve connected to the fuel cell stack, the radiator, the coolant supply pump, and the COD heater to control a flow of the coolant, and a controller configured to control an operating start time and output of the COD heater to consume energy generated by the fuel cell stack depending on a state of charge (SOC) of a battery and an operating state of the fuel cell stack. The controller controls the valve so that the coolant flows to the COD heater in a temperature control section after a cold start section of the fuel cell stack.

### CROSS-REFERENCE TO RELATED APPLICATION

This application claims under 35 U.S.C. § 119(a) the benefit of Korean Patent Application No. 10-2021-0158203 filed on Nov. 17, 2021, the entire contents of which are incorporated herein by reference.

### TECHNICAL FIELD

Embodiments of the present disclosure relate to a fuel cell system capable of consuming the energy generated by a fuel cell stack by controlling a COD heater.

### DESCRIPTION OF RELATED BACKGROUND ART

Among the main components of a fuel cell system, a fuel cell stack is a type of power generation device that generates electrical energy through a chemical reaction between oxygen in the air and externally supplied hydrogen. A fuel cell system applied to a vehicle includes a fuel cell stack for generating electrical energy through the electrochemical reaction of reactant gas (hydrogen as fuel and oxygen as an oxidant), a hydrogen supply device for supplying hydrogen as fuel to the fuel cell stack, an air supply device for supplying air containing oxygen to the fuel cell stack, a heat and water management system for controlling the operating temperature of the fuel cell stack and performing a water management function, and a controller for controlling the overall operation of the fuel cell system.

Meanwhile, the fuel cell system is required to control a COD heater, for example, during a cold start, when the vehicle travels on a downhill road, or when the fuel cell stack is shut down. Specifically, the fuel cell system performs heat control of the fuel cell stack using the COD heater in order to enable the fuel cell stack to operate normally during a low-temperature start. Reducing the cold start time is directly related to the quality of a vehicle, and it is therefore advantageous to complete the start in the shortest possible time.

In addition, the battery of the vehicle may be charged with regenerative braking energy generated during downhill driving. However, in the case of prolonged downhill driving or in the case in which the battery is already sufficiently charged, control is performed to consume the energy generated by regeneration using the COD heater in order to prevent overcharging of the battery. If this control is not performed, a driver has to continuously use a hydraulic brake during downhill driving, which may cause a decrease in product quality and, more seriously, may lead to a deterioration in braking performance.

However, when there is no required amount of power generation of the fuel cell stack after the cold start, the durability of the fuel cell stack may be deteriorated as the fuel cell stack is turned off In addition, when the energy generated by regenerative braking during downhill driving is greater than the energy consumed by the COD heater, regenerative braking is not performed and the hydraulic brake may intervene during downhill driving. In addition, when the COD heater is excessively operated during downhill driving, the energy stored in the battery may be consumed even when regenerative braking is performed, which leads to a deterioration in the fuel efficiency of the vehicle.

The above information disclosed in this Background section is only for enhancement of understanding of the background of the disclosure and therefore it may contain information that does not form the prior art that is already known in this country to a person of ordinary skill in the art.

### SUMMARY OF THE DISCLOSURE

The present disclosure has been made in an effort to solve the above-described problems associated with prior art.

In one embodiment, the present disclosure provides a fuel cell system capable of consuming the energy generated by a fuel cell stack in consideration of the state of charge of a battery.

In another embodiment, the present disclosure provides a fuel cell system capable of consuming energy using a COD heater in order to prevent a brake from intervening and perform regenerative braking while a vehicle travels on a downhill road.

In a further embodiment, the present disclosure provides a fuel cell system that operates a COD heater such that the state of charge of a battery does not exceed a limit.

In a preferred embodiment, a fuel cell system is provided. The fuel cell system includes a radiator configured to exchange heat with coolant discharged from a fuel cell stack, a coolant supply pump configured to supply the coolant to the fuel cell stack, a COD heater configured to consume electric power generated by the fuel cell stack, a valve connected to the fuel cell stack, the radiator, the coolant supply pump, and the COD heater to control a flow of the coolant, and a controller configured to control an operating start time and output of the COD heater to consume energy generated by the fuel cell stack depending on a state of charge (SOC) of a battery and an operating state of the fuel cell stack, wherein the controller is configured to control the valve so that the coolant flows to the COD heater in a temperature control section after a cold start section of the fuel cell stack.

When the fuel cell stack has a required amount of power generation of 0, the controller may limit an upper voltage limit of the fuel cell stack to operate the fuel cell stack at a net output. The net output of the fuel cell stack may correspond to a value obtained by subtracting an auxiliary equipment consumption output, which is an output consumed by high-voltage components constituting the fuel cell system, from an output at the upper voltage limit of the fuel cell stack.

When the state of charge of the battery is less than a preset level, the controller may cause the battery to be charged with energy produced by the net output of the fuel cell stack. When the state of charge of the battery is equal to or higher than the preset level, the controller may control the COD heater to generate an output corresponding to the net output of the fuel cell stack.

The COD heater may be provided therein with an IGBT and a COD controller to comply with the output received from the controller. The COD controller may determine a duty value obtained by dividing the output received from the controller by a maximum output of the COD heater for the voltage of the fuel cell stack.

The controller may predict a time when a vehicle enters a downhill road based on information received from a GPS device that searches for a driving route of the vehicle.

The controller may calculate regenerative power energy to be generated during downhill driving and rechargeable energy on the state of charge of the battery. The controller may control the COD heater to be turned off when the regenerative power energy is less than a sum of the rechargeable energy and auxiliary equipment consumption energy.

When the regenerative power energy is equal to or greater than the sum of the rechargeable energy and the auxiliary equipment consumption energy, the controller may determine whether to turn on the COD heater before the vehicle enters the downhill road based on a comparison between values obtained by subtracting the sum of the rechargeable energy and the auxiliary equipment consumption energy from COD consumption energy consumable by the COD heater and the regenerative power energy while the vehicle travels on the downhill road.

When the COD consumption energy is less than a value obtained by subtracting the sum of the rechargeable energy and the auxiliary equipment consumption energy from the regenerative power energy, the controller may control the COD heater to be turned on before the vehicle enters the downhill road.

The controller may control the COD heater to consume COD pre-consumption energy, which is a value obtained by subtracting a sum of the rechargeable energy, the auxiliary equipment consumption energy, and the COD consumption energy from the regenerative power energy, before the vehicle enters the downhill road.

The controller may control the COD heater to be turned on at a time that precedes a time when the vehicle is expected to enter the downhill road by a preceding time for COD operating obtained by dividing the COD pre-consumption energy by a maximum output of the COD heater.

After the vehicle enters the downhill road, the controller may compare a regenerative power output with a maximum output of the COD heater to determine an ON/OFF time of the COD heater such that the state of charge of the battery does not reach a limit.

When the COD heater is turned on and the regenerative power output exceeds the maximum output of the COD heater before the vehicle enters the downhill road, the controller may control the COD heater to be operated at a maximum output.

When the COD heater is turned on and the regenerative power output is less than or equal to the maximum output of the COD heater before the vehicle enters the downhill road, the controller may control the COD heater to be turned off.

When the COD heater is turned off and the regenerative power output exceeds the maximum output of the COD heater before the vehicle enters the downhill road, the controller may control the COD heater to be turned on.

When the COD heater is turned off and the regenerative power output is less than or equal to the maximum output of the COD heater before the vehicle enters the downhill road, the controller may control the COD heater to be turned off.

When the state of charge of the battery reaches the limit by regenerative braking of the vehicle, the controller may control the COD heater such that its output is equal to the regenerative power output.

The controller may control the COD heater to be turned off when the vehicle exits the downhill road.

The fuel cell system may further include a heater core disposed between the COD heater and the valve, a PTC heater for vehicle interior heating, and an air conditioning controller configured to control the PTC heater. When an inlet temperature of the fuel cell stack is less than a required temperature of the heater core, the air conditioning controller may transmit a command to turn on the COD heater to the controller.

When an inlet temperature of the heater core is less than the required temperature of the heater core after the COD heater is turned on, the air conditioning controller may transmit a command to increase an output of the COD heater to the controller.

When the inlet temperature of the fuel cell stack is equal to or higher than the required temperature of the heater core, and when the inlet temperature of the heater core is equal to or higher than the required temperature of the heater core after the COD heater is turned on, the air conditioning controller may control an output of the PTC heater by a value obtained by subtracting an amount of heat supplied by the heater core from a required amount of heating. The amount of heat supplied by the heater core may be calculated based on the inlet temperature of the heater core, the inlet temperature of the fuel cell stack, and heat transfer efficiency of the heater core.

As discussed, the method and system suitably include use of a controller or processer.

In another embodiment, vehicles are provided that comprise an apparatus as disclosed herein.

Other embodiments and preferred embodiments of the disclosure are discussed infra.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a diagram illustrating a fuel cell system according to an exemplary embodiment of the present disclosure;

FIG. 2 is a graph illustrating a valve control method for an operating mode of a fuel cell stack according to the embodiment of the present disclosure;

FIG. 3 is a flowchart illustrating a control method of the fuel cell system when the required amount of power generation of the fuel cell stack is zero according to the embodiment of the present disclosure;

FIG. 4 is a flowchart illustrating a COD heater control method before a vehicle enters a downhill road according to the embodiment of the present disclosure;

FIG. 5 is a flowchart illustrating a COD heater control method after the vehicle enters the downhill road according to the embodiment of the present disclosure;

FIGS. 6 and 7 are graphs for explaining an operating time of a COD heater according to the embodiment of the present disclosure;

FIG. 8 is a diagram illustrating a COD heater control system for assisting in heating of the interior of the vehicle according to the embodiment of the present disclosure;

FIG. 9 is a flowchart illustrating a COD heater control method for assisting in heating of the interior of the vehicle according to the embodiment of the present disclosure; and

FIG. 10 is a flowchart illustrating a valve control method for ensuring durability of an ion filter according to the embodiment of the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, reference will be made in detail to various embodiments of the present disclosure, examples of which are illustrated in the accompanying drawings and described below. While the disclosure will be described in conjunction with exemplary embodiments, it will be understood that the present description is not intended to limit the disclosure to the exemplary embodiments. On the contrary, the disclosure is intended to cover not only the exemplary embodiments, but also various alternatives, modifications, equivalents and other embodiments, which may be included within the spirit and scope of the disclosure as defined by the appended claims.

Advantages and features of the present disclosure and methods of achieving the same will become apparent with reference to the embodiments described below in detail in conjunction with the accompanying drawings. The present disclosure may, however, be embodied in different forms, and should not be construed as being limited to the embodiments set forth herein. Rather, these embodiments are provided so that the disclosure will be thorough and complete, and will fully convey the scope of the present disclosure to those skilled in the art. The present disclosure should be defined based on the entire content set forth in the appended claims. Throughout the disclosure, like reference numerals refer to like components.

The term “. . . part”, “. . . unit”, “. . . module”, or the like used herein refers to a unit for processing at least one function or operation, which may be implemented by hardware, software, or a combination thereof.

In addition, terms such as “first” and “second” may be used herein to describe components in the embodiments of the present disclosure. These terms do not limit the order or sequence of the components indicated thereby in the following description.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

The detailed description herein is merely illustrative of the present disclosure. The description herein is given with respect to preferred embodiments of the present disclosure, and it will be apparent to those skilled in the art that the present disclosure can be used in various other combinations, modifications, and environments. That is, it will be apparent to those skilled in the art that various changes and modifications may be made without departing from the spirit or scope of the disclosure as defined in the following claims. The embodiment to be described below represents the best mode for implementing the technical idea of the present disclosure, but it will be apparent to those skilled in the art that various changes are possible as required for specific applications and uses of the present disclosure. Accordingly, the details described herein are not intended to limit the present disclosure to the disclosed embodiments. Moreover, the appended claims should be construed to encompass other embodiments as well.

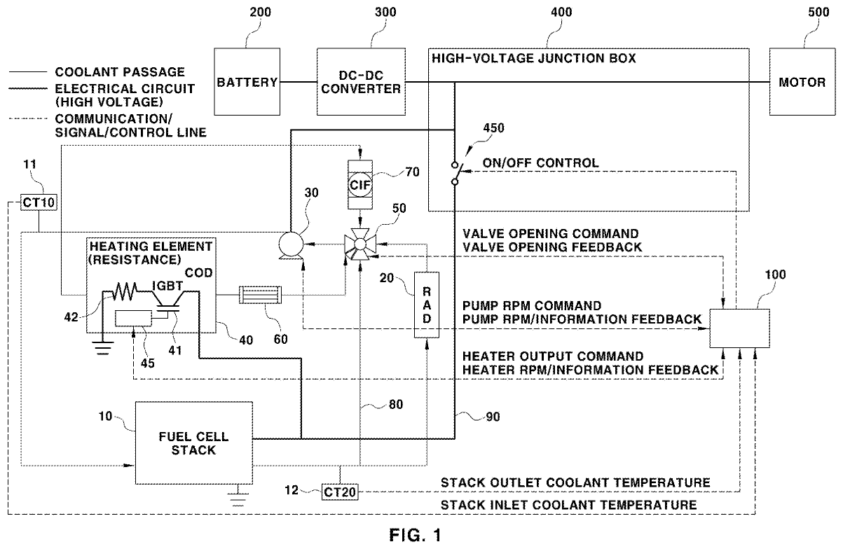

FIG. 1 is a diagram illustrating a fuel cell system according to an exemplary embodiment of the present disclosure.

Referring to FIG. 1, the fuel cell system may include a fuel cell stack 10, a radiator 20, a coolant supply pump 30, a cathode oxygen depletion (COD) heater 40, a valve 50, a heater core 60, and an ion filter 70.

The fuel cell stack 10 may generate electric power through a chemical reaction between air and hydrogen supplied thereto. In order to dissipate heat, which is a by-product generated by the chemical reaction in the fuel cell stack 10, coolant may be introduced into the fuel cell stack 10.

The inlet and the outlet of the fuel cell stack 10 may be provided with temperature sensors 11 and 12 for measuring the temperature of the coolant flowing into or out of the fuel cell stack 10. The temperature sensors 11 and 12 may include a first temperature sensor 11 for measuring the temperature of the coolant flowing into the fuel cell stack 10 and a second temperature sensor 12 for measuring the temperature of the coolant flowing out of the fuel cell stack 10.

The radiator 20 may again cool the coolant, the temperature of which is increased after the chemical reaction in the fuel cell stack 10. The radiator 20 may radiate heat from the coolant to the outside. The coolant cooled by the radiator 20 may flow to the valve 50.

The coolant supply pump 30 may supply the coolant delivered from the valve 50 to the fuel cell stack 10 or the COD heater 40. The coolant supply pump 30 may control the flow rate of the coolant.

The COD heater 40 may increase the temperature of the coolant if necessary or may consume the electric power, generated in the fuel cell stack 10, to release the same as heat to decrease the voltage of the fuel cell stack 10. In particular, if regenerative braking is continuously performed when the fuel cell system is turned on or off and when the state of charge (SOC) of a battery 200 is sufficient, the COD heater 40 may be operated to consume the electric power generated by the fuel cell stack 10. In addition, the COD heater 40 may consume the electric power generated during regenerative braking of the vehicle when the state of charge of the battery 200 is sufficient.

The COD heater 40 may be provided therein with an insulated gate bipolar transistor (IGBT) 41 for controlling the output of the COD heater 40, a heating element 42, and a COD controller 45. The COD heater 40 may be provided with a sensor (not shown) for measuring the temperature of the COD heater 40. The COD controller 45 may perform PWM duty control in response to the command output from a controller 100. Specifically, the output of the COD heater 40 may be calculated by the controller 100 according to the voltage of the fuel cell stack 10, and the COD controller 45 may determine a duty value, which is the ratio between the output of the COD heater 40 and the maximum output of the COD heater 40 received from the controller 100. The IGBT 41 may be controlled based on the duty value determined by the COD controller 45.

The opening and closing of the valve 50 may be controlled for a control mode of the fuel cell system. The valve 50 may be a 5-way valve. The coolant may flow from the fuel cell stack 10, the radiator 20, the COD heater 40, and the ion filter 70 toward the valve 50, and may flow from the valve 50 toward the coolant supply pump 30. The flow rate and flow direction of the coolant may be controlled by opening and closing the valve 50. Specifically, an area for each passage through which the coolant passes may be controlled according to the opening degree (or angle of rotation) of the valve 50. The control of the valve 50 may allow the coolant discharged from the fuel cell stack 10 to flow through a bypass passage 80 to the valve 50 without passing through the radiator 20.

The heater core 60 may transfer the heat of the coolant to an air conditioner (not shown) for heating of the interior of the vehicle. The heater core 60 may be disposed at the rear end of the COD heater 40. Specifically, the heater core 60 may be disposed between the COD heater 40 and the valve 50. Accordingly, the inlet temperature of the heater core 60 may be affected by the output of the COD heater 40.

The ion filter 70 may remove ions contained in the coolant. The ion filter 70 may remove ions from the coolant provided by the coolant supply pump 30, and the coolant from which the ions are removed may be delivered to the valve 50.

The battery 200 may be charged with the energy generated by the fuel cell stack 10. The energy generated by the fuel cell stack 10 may be transferred through a main bus terminal 90 to a high-voltage junction box 400 including a switch 450. The switch 450 may complete or interrupt the electrical connection between the fuel cell stack 10 and the high-voltage junction box 400 and the electrical connection between the battery 200 and the main bus terminal 90.

A DC-DC converter 300 may convert the output of the battery 200 to a voltage which is provided to the same to the main bus terminal 90, or may convert the electric power input from the main bus terminal 90 to a voltage suitable for charging the battery 200.

A motor 500 may generate electric power to charge the battery 200 when regenerative braking of the vehicle is performed. In particular, when the vehicle travels on a downhill road or an engine brake is operated, regenerative braking by the motor 500 may generate braking force and simultaneously generate electric power used to charge the battery 200.

The controller 100 may electrically disconnect the battery 200 from the main bus terminal 90. The electrical disconnection of the battery 200 from the main bus terminal 90 may be implemented in such a manner that the controller 100 controls a relay (not shown) provided inside the battery 200 to disconnect the battery 200 from the DC-DC converter 300 or the controller 100 opens the switch 450 in the high-voltage junction box 400 to electrically disconnect the battery 200 from the main bus terminal 90.

The controller 100 may control the coolant supply pump 30, the COD heater 40, and the valve 50 to control the temperature of the fuel cell stack 10. Specifically, the controller 100 may receive information on the operating rotational speed (RPM), power consumption, and fault diagnosis of the coolant supply pump 30, and may control the rotational speed (RPM) of the coolant supply pump 30 based on the received information. The controller 100 may receive information on the actual output, current consumption, temperature, and fault diagnosis of the COD heater 40, and may control the ON/OFF operation and output of the COD heater 40 based on the received information. The controller 100 may monitor the temperature of the coolant received from the temperature sensors 11 and 12 to control the flow rate and temperature of the coolant. To this end, the controller 100 may control the opening degree of the valve 50. As the opening degree of the valve 50 is controlled, the opening degree of each of the five ports connected to the valve 50 may be changed.

As an example, the controller 100 may control the operation and start time of operation of the COD heater 40 to consume the energy generated by the fuel cell stack 10 depending on the state of charge of the battery 200 and the operating section of the fuel cell stack 10. The operating section of the fuel cell stack 10 may include a cold start section, a temperature control section, and a high-output section. In the embodiment of the present disclosure, the method of controlling the COD heater 40 in the temperature control section of the fuel cell stack 10 will be described.

As an example, the controller 100 may control the IGBT 41 located in the COD heater 40 and the switch 450 so that the electric power remaining in the main bus terminal 90 is consumed through the heating element 42 within the COD heater 40. When it is difficult to charge the battery 200 with the energy produced in the fuel cell stack 10, the controller 100 may consume the energy produced in the fuel cell stack 10 using the COD heater 40.

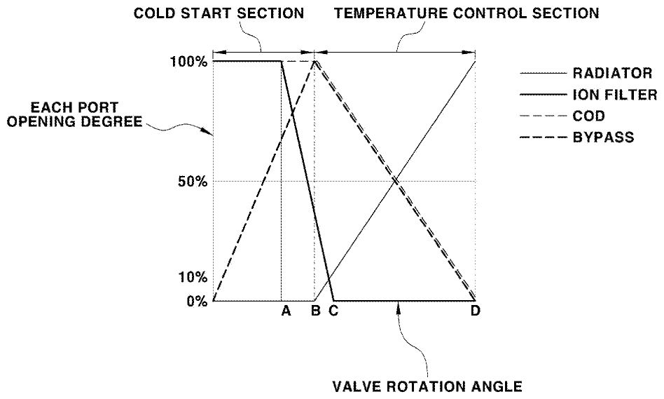

FIG. 2 is a graph illustrating a valve control method for an operating mode of the fuel cell stack according to the embodiment of the present disclosure. In FIG. 2, the x-axis refers to an angle of rotation of the valve, and the y-axis refers to an opening degree of each port connected to the valve.

Referring to FIGS. 1 and 2, as the controller 100 controls the opening degree of the valve 50, the opening degree of each of the five ports connected to the valve 50 may be changed. When the angle of rotation of the valve 50 is between 0 degrees and A degrees, the ion filter 70 may be fully opened. The section in which the angle of rotation of the valve 50 is between 0 degrees and B degrees may be a cold start section of the fuel cell stack 10. In this section, the port of the valve 50 connected to the radiator 20 may be closed, and the port of the valve 50 connected to the COD heater 40 may be fully opened. That is, in the cold start section of the fuel cell stack 10, the temperature of the coolant is increased by the COD heater 40.

When the angle of rotation of the valve 50 is between B degrees and C degrees, the port of the valve 50 connected to the ion filter 70 may be partially opened. At this time, the port of the valve 50 connected to the radiator 20 may be partially opened. The section in which the angle of rotation of the valve 50 is between B degrees and C degrees is a part of the temperature control section, but may be a section in which, when the fuel cell stack 10 is operated, the coolant flows to the ion filter 70 to thereby control the insulation resistance of the fuel cell system.

When the angle of rotation of the valve 50 is between C degrees and D degrees, the port of the valve 50 connected to the radiator 20 may be opened and the port of the valve 50 connected to the ion filter 70 may be fully closed. When the hot coolant flows into the ion filter 70, the durability of the ion filter 70 may be decreased. Accordingly, in the temperature control section of the fuel cell stack 10, the hot coolant may not flow into the ion filter 70, thereby ensuring the durability of the ion filter 70.

The section in which the angle of rotation of the valve 50 is between B degrees and D degrees may be defined as a temperature control section of the fuel cell stack 10. In the temperature control section of the fuel cell stack 10, the port of the valve 50 connected to the COD heater 40 may be kept open. That is, the coolant may flow into the COD heater 40 even when the vehicle travels normally. That is, the controller 100 may control the valve 50 such that the coolant flows to the COD heater 40 in the temperature control section after the cold start section of the fuel cell stack 10, so as to consume energy using the COD heater 40 even while the vehicle travels.

In the above description, D degrees may be greater than C degrees, C degrees may be greater than B degrees, and B degrees may be greater than A degrees.

In the embodiment of the present disclosure, the port of the valve 50 connected to the COD heater 40 may be opened so that the coolant flows to the COD heater 40 in the temperature control section after the cold start section of the fuel cell stack 10. Accordingly, it may be possible to control the COD heater 40 for consuming the energy generated by regenerative braking of the vehicle.

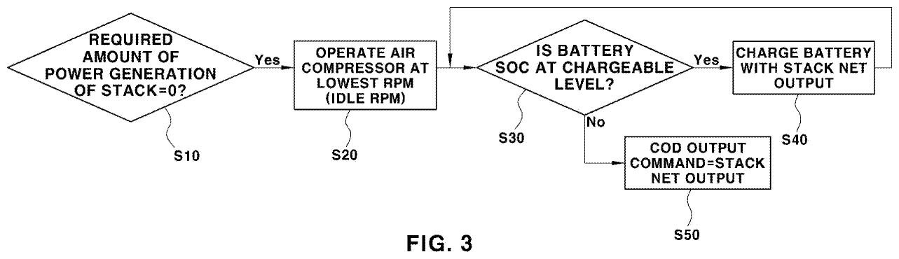

FIG. 3 is a flowchart illustrating a control method of the fuel cell system when the required amount of power generation of the fuel cell stack is zero according to the embodiment of the present disclosure.

Referring to FIGS. 1 to 3, when the required amount of power generation of the fuel cell stack 10 is 0, the controller 100 may limit the upper voltage limit of the fuel cell stack 10. As the upper voltage limit of the fuel cell stack 10 is limited, the voltage of the fuel cell stack 10 may be prevented from becoming an open circuit voltage (OCV). When the required amount of power generation of the fuel cell stack 10 is 0, this may indicate a situation in which the fuel cell stack 10 does not need to be operated after the fuel cell stack 10 is cold-started. For example, when the required amount of power generation of the fuel cell stack 10 is 0, this may indicate an idle stop state, the state in which the vehicle travels on the downhill road without depressing an accelerator pedal, or the like (S10).

When the required amount of power generation of the fuel cell stack 10 is 0, the controller 100 may operate the fuel cell stack 10 at a net output rather than stopping the fuel cell stack 10 in the interest of the durability of the fuel cell stack 10. In order to operate the fuel cell stack 10 at a net output, the controller 100 may operate an air compressor (not shown) at the lowest rotational speed (RPM), the air compressor serving to supply oxygen to the fuel cell stack 10. As an example, the net output of the fuel cell stack 10 may refer to a value obtained by subtracting an auxiliary equipment consumption output from the value obtained by multiplying the upper voltage limit of the fuel cell stack 10, the reaction area of the fuel cell stack 10, the number of stacked cells, and the current density at the upper voltage limit of the fuel cell stack 10 together. The auxiliary equipment consumption output may be an output consumed by the constituent devices of the fuel cell system except for the fuel cell stack 10. For example, the auxiliary equipment may include all pumps (not shown) for supplying oxygen and fuel to the fuel cell stack 10 in addition to the coolant supply pump 30, the COD heater 40, the valve 50, the heater core 60, and the ion filter 70. In other words, the net output of the fuel cell stack 10 may refer to a value obtained by subtracting the auxiliary equipment consumption output, which is the output consumed by the constituent high-voltage components of the fuel cell system, from the output at the upper voltage limit of the fuel cell stack 10 (S20).

The controller 100 may monitor the state of charge of the battery 200. When the state of charge of the battery 200 is equal to or higher than a preset level, the controller 100 may not cause the battery 200 to be charged (S30).

When the state of charge of the battery 200 is less than the preset level, the controller 100 may cause the battery 200 to be charged with the energy produced by the net output of the fuel cell stack 10 (S40).

When the state of charge of the battery 200 is equal to or higher than the preset level, the controller 100 may control the COD heater 40 to generate an output corresponding to the net output of the fuel cell stack 10. When the state of charge of the battery 200 is equal to or higher than the preset level, no current may be applied to the DC-DC converter 300. Accordingly, the controller 100 may turn on the COD heater 40 to consume the energy generated by the net output of the fuel cell stack 10 (S50).

According to the embodiment of the present disclosure, even if there is no required amount of power generation of the fuel cell stack 10 after the fuel cell stack 10 is cold-started, the energy generated by the fuel cell stack 10 can be consumed by the COD heater 40 without stopping the fuel cell stack 10. This can prevent the durability of the fuel cell stack 10 from being deteriorated due to frequent stopping and operating of the fuel cell stack 10.

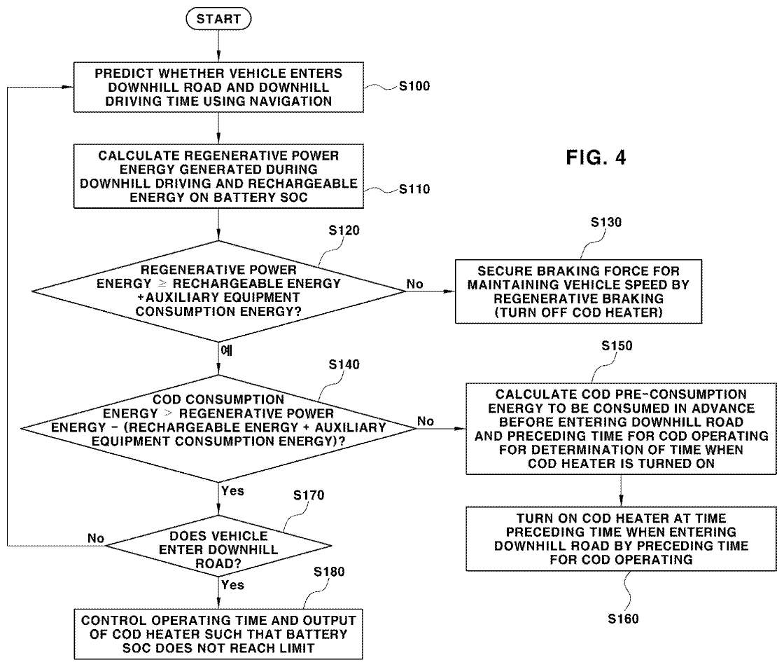

FIG. 4 is a flowchart illustrating a method of controlling the COD heater before the vehicle enters the downhill road according to the embodiment of the present disclosure.

Referring to FIGS. 1 and 4, the controller 100 may predict a time when the vehicle enters the downhill road based on the information received from a GPS device that searches for the driving route of the vehicle. The GPS device may be mounted on the vehicle. When the accelerator is kept off while the vehicle travels on the downhill road, the motor 500 may perform regenerative braking. In addition, the controller 100 may predict a time for which the vehicle travels on the downhill road based on information such as a current vehicle speed and road gradient (S100).

The controller 100 may calculate the regenerative power energy to be generated during downhill driving and the rechargeable energy on the state of charge of the battery 200. The regenerative power energy may be calculated based on the expected downhill driving time and regenerative power output of the vehicle. The rechargeable energy may be calculated based on the current state of charge of the battery 200 (S110).

The controller 100 may compare the regenerative power energy with the sum of the rechargeable energy and the auxiliary equipment consumption energy. The controller 100 may determine whether to turn on the COD heater 40 before the vehicle enters the downhill road based on the comparison between the regenerative power energy with the sum of the rechargeable energy and the auxiliary equipment consumption energy (S120).

The controller 100 may turn off the COD heater 40 when the regenerative power energy is less than the sum of the rechargeable energy and the auxiliary equipment consumption energy. When the regenerative power energy is less than the sum of the rechargeable energy and the auxiliary equipment consumption energy, this may indicate that the battery 200 is chargeable with the energy generated by regenerative braking of the motor 500. In this case, it is possible to secure a braking force for maintaining the speed of the vehicle only by regenerative braking of the vehicle (S130).

When the regenerative power energy is equal to or greater than the sum of the rechargeable energy and the auxiliary equipment consumption energy, the controller 100 may determine whether to turn on the COD heater 40 before the vehicle enters the downhill road based on the comparison between values obtained by subtracting the sum of the rechargeable energy and the auxiliary equipment consumption energy from the COD consumption energy consumed by the COD heater 40 and the regenerative power energy while the vehicle travels on the downhill road. The COD consumption energy may be calculated as a value obtained by multiplying the maximum output of the COD heater 40 by the expected time for which the vehicle travels on the downhill road (S140).

When the COD consumption energy is less than a value obtained by subtracting the sum of the rechargeable energy and the auxiliary equipment consumption energy from the regenerative power energy, the controller 100 may turn on the COD heater 40 before the vehicle enters the downhill road. The controller 100 may determine the time when the COD heater 40 is turned on and the output of the COD heater 40 in order to turn on the COD heater 40 in advance. The controller 100 may control the COD heater 40 to consume the COD pre-consumption energy, which is a value obtained by subtracting the sum of the rechargeable energy, the auxiliary equipment consumption energy, and the COD consumption energy from the regenerative power energy before the vehicle enters the downhill road. That is, the controller 100 may operate the COD heater 40 to consume the COD pre-consumption energy. In addition, the controller 100 may calculate the preceding time for COD operating obtained by dividing the COD pre-consumption energy by the maximum output of the COD heater 40. The controller 100 may turn on the COD heater 40 at a time that precedes the time when the vehicle is expected to enter the downhill road by the preceding time for COD operating. As a result, the controller 100 may operate the COD heater 40 at the time that precedes the time when the vehicle is expected to enter the downhill road by the preceding time for COD operating, thereby consuming the COD pre-consumption energy. This enables the vehicle to perform regenerative braking, even when the state of charge of the battery 200 is high (S150 and S160).

The controller 100 may check that the vehicle enters the downhill road. The controller 100 may control the operating time and output of the COD heater 40 by continuously calculating the COD pre-consumption energy and the preceding time for COD operating until the vehicle enters the downhill road (S170).

Even after the vehicle enters the downhill road, the state of charge of the battery 200 and the energy generated by regenerative power generation in practice may be changed depending on the speed of the vehicle and the gradient of the road. Accordingly, the controller 100 performs feedback control on the operating time of the COD heater 40 and the output of the COD heater 40 such that the state of charge of the battery 200 does not reach a limit even after the vehicle enters the downhill road (S180).

According to the embodiment of the present disclosure, regenerative braking of the vehicle is required to maintain the speed of the vehicle without intervention of the brake while the vehicle travels on the downhill road. In order to continuously perform regenerative braking while the vehicle travels on the downhill road, the controller 100 may operate the COD heater 40 before the vehicle enters the downhill road to lower the state of charge of the battery 200 in advance. When the state of charge of the battery 200 is high, regenerative braking may not be possible, but the controller 100 may cause the COD heater 40 to consume the energy charged in the battery 200 in order to continuously perform regenerative braking. This enables intervention of the brake to be restricted without performing regenerative braking when the vehicle travels on the downhill road.

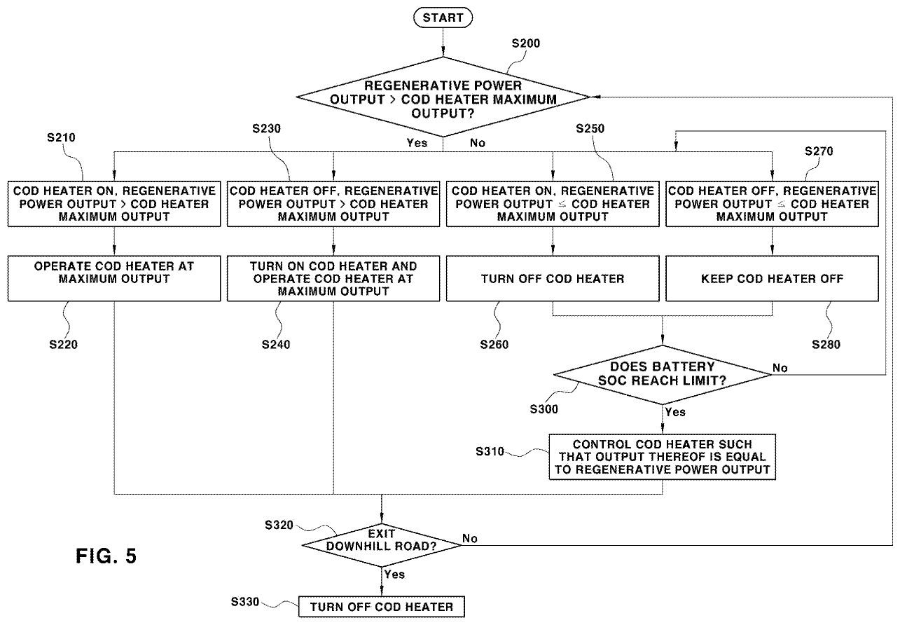

FIG. 5 is a flowchart illustrating a method of controlling the COD heater after the vehicle enters the downhill road according to the embodiment of the present disclosure.

Referring to FIGS. 1, 4, and 5, in order to exclude a situation in which the brake is required to operate when the state of charge of the battery 200 reaches a limit after the vehicle enters the downhill road, the controller 100 may determine the operating time of the COD heater 40 by comparing the regenerative power output with the maximum output of the COD heater 40. The regenerative power output may be an output generated by regenerative braking of the motor 500, and the maximum output of the COD heater 40 may be a maximum output for the voltage of the fuel cell stack 10 (S200).

When the COD heater 40 is turned on before the vehicle enters the downhill road and the regenerative power output exceeds the maximum output of the COD heater 40, the controller 100 may operate the COD heater 40 at a maximum output. Before the vehicle enters the downhill road, the COD heater 40 is operated at an output for consuming the COD pre-consumption energy. Accordingly, the controller 100 may increase the output of the COD heater 40 to the maximum output. The COD pre-consumption energy may be less than or equal to the energy consumed by the maximum output of the COD heater 40. When the regenerative power output exceeds the maximum output of the COD heater 40, this may indicate that the COD heater 40 does not consume all of the energy generated by the regenerative power output. However, since the COD heater 40 has consumed the energy stored in the battery 200 as much as the COD pre-consumption energy before the vehicle enters the downhill road, the battery 200 may be chargeable with energy obtained by subtracting the energy consumed by the maximum output of the COD heater 40 from the energy generated by the regenerative power output. Therefore, the vehicle may continuously perform regenerative braking without the intervention of the brake while traveling on the downhill road (S210 and S220).

When the COD heater 40 is turned off before the vehicle enters the downhill road and the regenerative power output exceeds the maximum output of the COD heater 40, the controller 100 may turn on the COD heater 40 and operate the COD heater 40 at a maximum output. When the regenerative power output exceeds the maximum output of the COD heater 40, this may indicate that the COD heater 40 does not consume all of the energy generated by the regenerative power output. However, since additional energy may be stored in the battery 200 before the vehicle enters the downhill road, the battery 200 may be chargeable with energy obtained by subtracting the energy consumed by the maximum output of the COD heater 40 from the energy generated by the regenerative power output. Therefore, the vehicle may continuously perform regenerative braking without the intervention of the brake while traveling on the downhill road (S230 and S240).

When the COD heater 40 is turned on before the vehicle enters the downhill road and the regenerative power output is less than or equal to the maximum output of the COD heater 40, the controller 100 may turn off the COD heater 40. Before the vehicle enters the downhill road, the COD heater 40 is operated at an output for consuming the COD pre-consumption energy. In the current state of the vehicle, all of the energy generated by regenerative power generation is consumable by the COD heater 40. Therefore, continuous regenerative braking of the vehicle may be possible even though the COD heater 40 is operated from the time when the state of charge of the battery 200 reaches a limit. In other words, the controller 100 may not operate the COD heater 40 until the state of charge of the battery 200 reaches a limit in the interest of improving fuel efficiency of the vehicle (S250 and S260).

When the COD heater 40 is turned off before the vehicle enters the downhill road and the regenerative power output is less than or equal to the maximum output of the COD heater 40, the controller 100 may keep the COD heater 40 off. In the current state of the vehicle, all of the energy generated by regenerative power generation is consumable by the COD heater 40. Therefore, continuous regenerative braking of the vehicle may be possible even though the COD heater 40 is operated from the time when the state of charge of the battery 200 reaches a limit. In other words, the controller 100 may not operate the COD heater 40 until the state of charge of the battery 200 reaches the limit in the interest of the improvement in fuel efficiency of the vehicle (S270 and S280).

In the state in which the COD heater 40 is turned off, the battery 200 may be charged with the energy generated by regenerative power, and the state of charge of the battery 200 may reach a limit (S300).

When the state of charge of the battery 200 reaches the limit, the controller 100 may control the COD heater 40 such that the output of the COD heater 40 is equal to the regenerative power output. Since the limit of the state of charge of the battery 200 indicates that the battery 200 is not fully charged, the controller 100 may control the COD heater 40 when the state of charge of the battery 200 reaches the limit. In addition, in order to prevent a deterioration in fuel efficiency of the vehicle, the controller 100 may control the COD heater 40 under the same output as the regenerative power generation output without excessively increasing the output of the COD heater 40 (S310).

The controller 100 may monitor that the vehicle exits the downhill road. Until the vehicle exits the downhill road, the controller 100 may continuously monitor the comparison between the regenerative power generation output and the maximum output of the COD heater and the state of charge of the battery 200. The controller 100 may control the COD heater 40 such that the state of charge of the battery 200 does not exceed a limit due to regenerative power generation (S320).

The controller 100 may turn off the COD heater 40 when the vehicle exits the downhill road (S330).

According to the embodiment of the present disclosure, it is possible to control the ON/OFF time of the COD heater 40 and the output of the COD heater 40 in the interest of the improvement in fuel efficiency of the vehicle after the vehicle enters the downhill road. It is possible to improve the fuel efficiency of the vehicle by preventing excessive operating of the COD heater 40, and to perform continuous regenerative braking of the vehicle as the operating time of the COD heater 40 is determined such that the state of charge of the battery 200 does not exceed the limit.

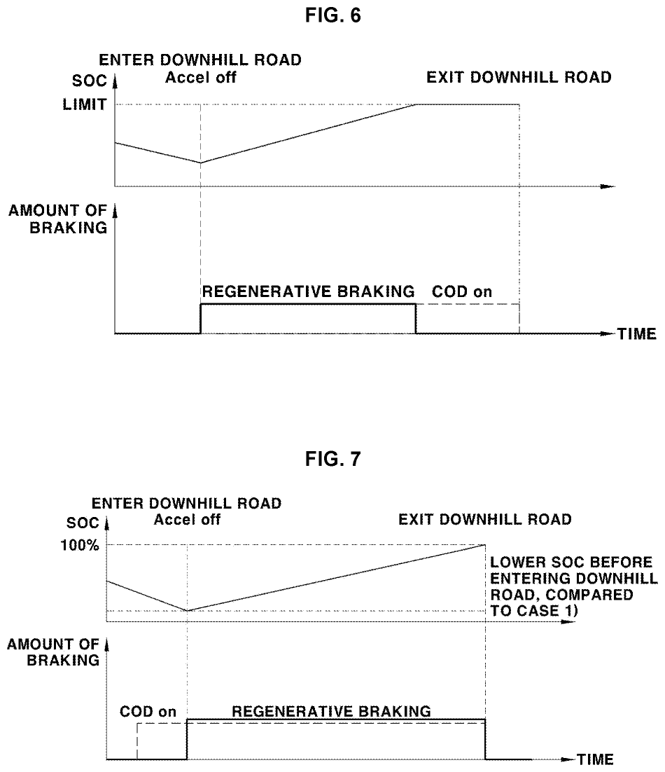

FIGS. 6 and 7 are graphs for explaining the operating time of the COD heater according to the embodiment of the present disclosure. FIG. 6 illustrates that the COD heater is not operated before the vehicle enters the downhill road, and FIG. 7 illustrates that the COD heater is operated before the vehicle enters the downhill road. FIG. 6 illustrates that the regenerative power output is less than or equal to the maximum output of the COD heater, and FIG. 7 illustrates that the regenerative power output is greater than the maximum output of the COD heater.

Referring to FIGS. 4 to 6, FIG. 6 illustrates step S270 of FIG. 5. The COD heater may not be operated before the vehicle enters the downhill road, and regenerative braking of the motor may be performed while the vehicle enters the downhill road. When the vehicle enters the downhill road, the state of charge of the battery has not reached a limit. The battery may be gradually charged as regenerative braking is performed. When the state of charge of the battery reaches a limit, the controller operates the COD heater to consume the energy generated by regenerative power generation. Accordingly, the state of charge of the battery may not reach the limit until the vehicle exits the downhill road.

Referring to FIGS. 4, 5, and 7, FIG. 7 illustrates step S210 of FIG. 5. Before the vehicle enters the downhill road, the COD heater may be operated to consume the energy charged in the battery. Accordingly, the energy of the battery may be consumed more before the vehicle enters the downhill road, compared to the case of FIG. 6. As the vehicle enters the downhill road, the motor may perform regenerative braking. When the vehicle enters the downhill road, the state of charge of the battery has not reached a limit.

Since the regenerative power output is greater than the maximum output of the COD heater, the battery may be gradually charged during regenerative braking. The controller may cause the COD heater to be operated at a maximum output to consume some of the energy generated by regenerative power generation. Since the COD heater consumes the energy charged in the battery in advance before the vehicle enters the downhill road, the state of charge of the battery may not reach the limit until the vehicle exits the downhill road.

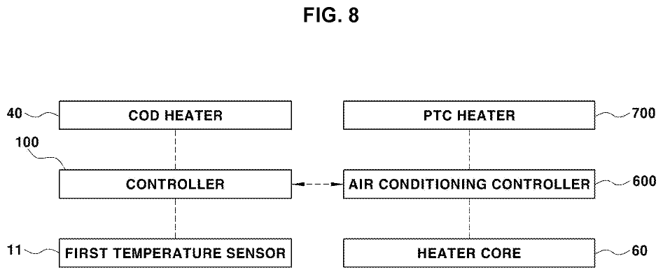

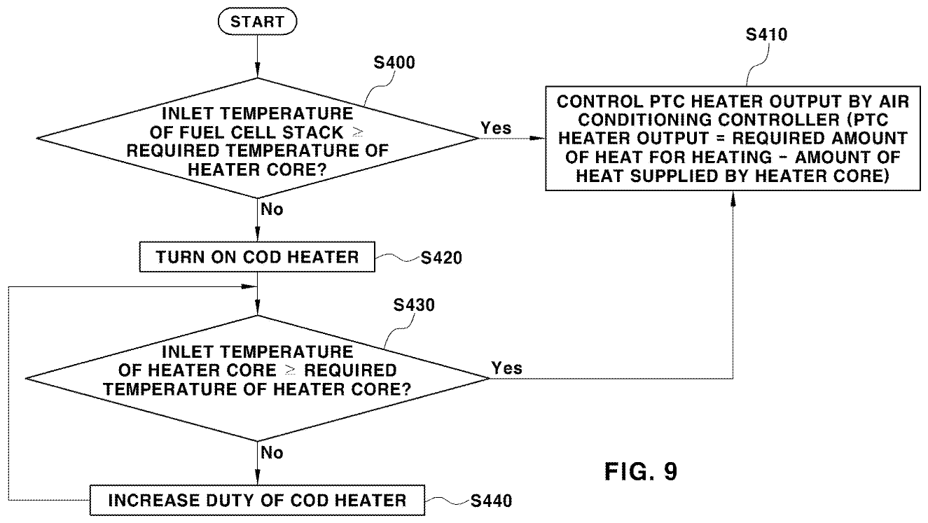

FIG. 8 is a diagram illustrating a COD heater control system for assisting in heating of the interior of the vehicle according to the embodiment of the present disclosure. FIG. 9 is a flowchart illustrating a method of controlling the COD heater for assisting in heating of the interior of the vehicle according to the embodiment of the present disclosure. For simplicity of description, a redundant description will be omitted below.

Referring to FIGS. 1, 8, and 9, the controller 100 may check the inlet temperature of the fuel cell stack 10 through the first temperature sensor 11. The controller 100 may compare the inlet temperature of the fuel cell stack 10 with the required temperature of the heater core 60. The required temperature of the heater core 60 may be calculated based on the signal received from an air conditioning controller 600 for heating of the interior of the vehicle. The air conditioning controller 600 may transmit the required temperature of the heater core 60 to the controller 100 for an interior heating temperature required by the occupant of the vehicle (S400).

When the inlet temperature of the fuel cell stack 10 is equal to or higher than the required temperature of the heater core 60, the air conditioning controller 600 may control the output of a PTC heater 700. The output of the PTC heater 700 may be a value obtained by subtracting the amount of heat supplied by the heater core 60 from the required amount of heating. The required amount of heating may be an amount of heat calculated by the air conditioning controller 600 for the interior heating temperature required by the passenger of the vehicle. That is, the required amount of heating may be calculated by adding the amount of heat supplied by the heater core 60 to the output of the PTC heater 700. The amount of heat supplied by the heater core 60 may be calculated by the inlet temperature of the heater core 60, the inlet temperature of the fuel cell stack 10, and the heat transfer efficiency of the heater core 60. The controller 100 may check the inlet temperature of the heater core 60 based on the inlet temperature of the fuel cell stack 10, the output of the COD heater 40, the specific heat of the coolant, the density of the coolant, and the flow rate of the coolant. The inlet temperature of the heater core 60 may be calculated by adding the inlet temperature of the fuel cell stack 10 to a value obtained by dividing the output of the COD heater 40 by the product of the specific heat of the coolant, the density of the coolant, and the flow rate of the coolant. The amount of heat supplied by the heater core 60 may be calculated by multiplying the difference between the inlet temperature of the heater core 60 and the inlet temperature of the fuel cell stack 10 by the heat transfer efficiency of the heater core 60, the specific heat of the coolant, the density of the coolant, and the flow rate of the coolant (S410).

When the inlet temperature of the fuel cell stack 10 is less than or equal to the required temperature of the heater core 60, the air conditioning controller 600 may transmit a command to turn on the COD heater 40 to the controller 100. The controller 100 may turn on the COD heater 40 in response to the command received from the air conditioning controller 600. The controller 100 may operate the COD heater 40 in order to secure the temperature of the coolant required for the heater core 60 (S420).

The controller 100 may compare the inlet temperature of the heater core 60 with the required temperature of the heater core 60 to determine the output of the COD heater 40. When the inlet temperature of the heater core 60 is equal to or higher than the required temperature of the heater core 60, the controller 100 may determine that it is not necessary to increase the output of the COD heater 40. Accordingly, the air conditioning controller 600 may control the output of the PTC heater 700 without controlling the output of the COD heater 40 to adjust the heating temperature required by the occupant (S430).

When the inlet temperature of the heater core 60 is less than or equal to the required temperature of the heater core 60, the air conditioning controller 600 may transmit a command to increase the output of the COD heater 40 to the controller 100. The controller 100 may increase the output of the COD heater 40 in response to the command received from the air conditioning controller 600. That is, the controller 100 may increase the duty of the COD heater 40 to increase the inlet temperature of the heater core 60 (S440).

According to an exemplary embodiment of the present disclosure, controlling the output of the COD heater 40 to increase the inlet temperature of the heater core 60 can be helpful for the air conditioning controller 600 to adjust the heating temperature required by the occupant of the vehicle. Since increasing the output of the COD heater 40 increases the inlet temperature of the heater core 60, the heater core 60 can assist the role of the PTC heater 700.

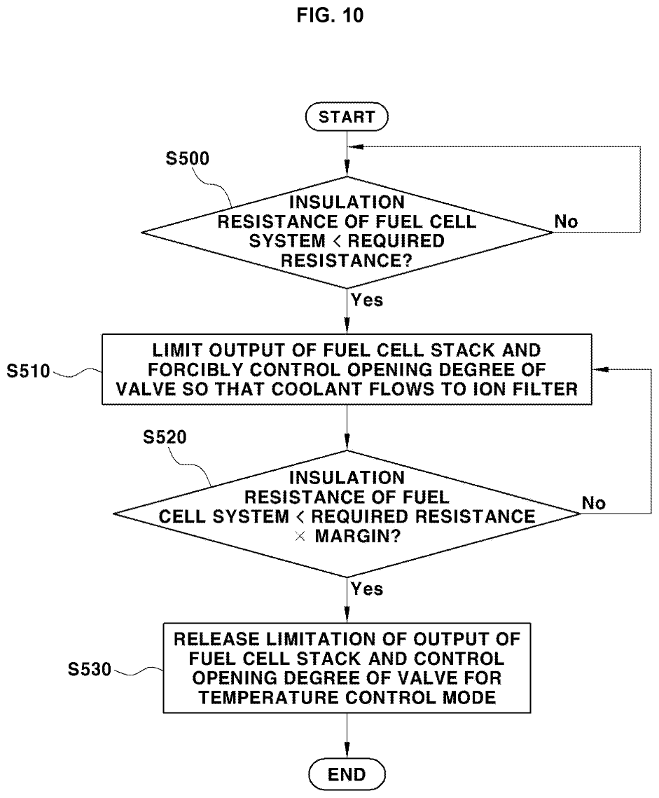

FIG. 10 is a flowchart illustrating the method of controlling the valve for ensuring durability of the ion filter according to the embodiment of the present disclosure.

Referring to FIGS. 1, 2, and 10, the controller 100 may measure an insulation resistance of the fuel cell system. The fuel cell system may be provided with an insulation resistance measurement device (not shown) for measuring an insulation resistance thereof. The controller 100 may compare the insulation resistance of the fuel cell system with a preset required resistance for the voltage of the fuel cell stack 10. Typically, the insulation resistance of the fuel cell system should be greater than the required resistance for the voltage of the fuel cell stack 10 (S500).

When the insulation resistance of the fuel cell system is less than the required resistance for the voltage of the fuel cell stack 10, the controller 100 may limit the output of the fuel cell stack 10 and forcibly control the opening degree of the valve 50. That is, the controller 100 may control the opening degree of the valve 50 such that some of the coolant flows to the ion filter 70. The output of the fuel cell stack 10 may be limited under a preset condition. In general, as the amount of ions contained in the coolant increases, the conductivity of the coolant may increase, and as the conductivity of the coolant increases, the insulation resistance may decrease. As the coolant flows into the ion filter 70, the amount of ions contained in the coolant may be reduced, thereby increasing the insulation resistance of the fuel cell system (S510).

After controlling the opening degree of the valve 50, the controller 100 may compare the insulation resistance of the fuel cell system with a value obtained by multiplying the required resistance for the voltage of the fuel cell stack 10 by a margin. For example, the margin may be set to be greater than 1. The controller 100 may compare the insulation resistance with a value obtained by multiplying the required resistance by the margin in order to prevent frequent changes in the opening degree of the valve 50 (S520).

When the insulation resistance of the fuel cell system is less than the value obtained by multiplying the required resistance for the voltage of the fuel cell stack 10 by the margin, the controller 100 may release the limitation of the output of the fuel cell stack 10 and control the opening degree of the valve 50 for a temperature control mode. That is, when the insulation resistance of the fuel cell system is increased to a normal level, the controller 100 may control the valve 50 based on the control logic of the temperature control section of the fuel cell stack 10 (S530).

According to the embodiment of the present disclosure, control may be performed so that the coolant flows to the ion filter 70 to satisfy the insulation resistance required for the fuel cell system. The durability of the ion filter 70 can be ensured by allowing the coolant to flow to the ion filter 70 only when the insulation resistance of the fuel cell system is less than the required resistance. In addition, the insulation performance of the system can be ensured due to the flow of the coolant to the ion filter 70.

As is apparent from the above description, according to the embodiment of the present disclosure, even if there is no required amount of power generation of the fuel cell stack after the fuel cell stack is cold-started, the energy generated by the fuel cell stack can be consumed by the COD heater without stopping the fuel cell stack. This can prevent the durability of the fuel cell stack from being deteriorated due to frequent stopping and actuating of the fuel cell stack.

According to the embodiment of the present disclosure, regenerative braking of the vehicle is required to maintain the speed of the vehicle without intervention of the brake while the vehicle travels on the downhill road. In order to continuously perform regenerative braking while the vehicle travels on the downhill road, the controller can operate the COD heater before the vehicle enters the downhill road to lower the state of charge of the battery in advance. When the state of charge of battery is high, regenerative braking may not be possible, but the controller can cause the COD heater to consume the energy charged in the battery in order to continuously perform regenerative braking. This enables intervention of the brake to be restricted without performing regenerative braking when the vehicle travels on the downhill road.

According to the embodiment of the present disclosure, it is possible to control the ON/OFF time of the COD heater and the output of the COD heater in the interest of the improvement in fuel efficiency of the vehicle after the vehicle enters the downhill road. It is possible to improve the fuel efficiency of the vehicle by preventing excessive operating of the COD heater, and to perform continuous regenerative braking of the vehicle as the operating time of the COD heater is determined such that the state of charge of the battery does not exceed the limit.

According to the embodiment of the present disclosure, controlling the output of the COD heater to increase the inlet temperature of the heater core can be helpful for the air conditioning controller to adjust the heating temperature required by the occupant of the vehicle. Since increasing the output of the COD heater increases the inlet temperature of the heater core, the heater core can assist the role of the PTC heater.

Although the present disclosure has been described with reference to preferred embodiments thereof, it will be understood by those skilled in the art that various modifications may be made without departing from the spirit and scope or essential features of the disclosure. Therefore, it should be understood that the embodiments described above are for purposes of illustration only in all embodiments and are not intended to limit the scope of the present disclosure.

What is claimed is:

1. A fuel cell system comprising:
a radiator configured to exchange heat with coolant discharged from a fuel cell stack;
a coolant supply pump configured to supply the coolant to the fuel cell stack;
a COD heater configured to consume electric power generated by the fuel cell stack;
a valve connected to the fuel cell stack, the radiator, the coolant supply pump, and the COD heater to control a flow of the coolant; and
a controller configured to control an operating start time and output of the COD heater to consume energy generated by the fuel cell stack depending on a state of charge (SOC) of a battery and an operating state of the fuel cell stack,
wherein the controller is configured to control the valve so that the coolant flows to the COD heater in a temperature control section after a cold start section of the fuel cell stack.

2. The fuel cell system according to claim 1, wherein:
when the fuel cell stack has a required amount of power generation of zero, the controller limits an upper voltage limit of the fuel cell stack to operate the fuel cell stack at a net output; and
the net output of the fuel cell stack corresponds to a value obtained by subtracting an auxiliary equipment consumption output, which is an output consumed by high-voltage components constituting the fuel cell system, from an output at the upper voltage limit of the fuel cell stack.

3. The fuel cell system according to claim 2, wherein:
when the state of charge of the battery is less than a preset level, the controller causes the battery to be charged with energy produced by the net output of the fuel cell stack; and
when the state of charge of the battery is equal to or higher than the preset level, the controller controls the COD heater to generate an output corresponding to the net output of the fuel cell stack.

4. The fuel cell system according to claim 1, wherein:
the COD heater is provided therein with an IGBT and a COD controller to comply with the output received from the controller; and
the COD controller determines a duty value obtained by dividing the output received from the controller by a maximum output of the COD heater for the voltage of the fuel cell stack.

5. The fuel cell system according to claim 1, wherein the controller predicts a time when a vehicle enters a downhill road based on information received from a GPS device that searches for a driving route of the vehicle.

6. The fuel cell system according to claim 5, wherein:
the controller calculates regenerative power energy to be generated during downhill driving and rechargeable energy on the state of charge of the battery; and
the controller controls the COD heater to be turned off when the regenerative power energy is less than a sum of the rechargeable energy and auxiliary equipment consumption energy.

7. The fuel cell system according to claim 6, wherein when the regenerative power energy is equal to or greater than the sum of the rechargeable energy and the auxiliary equipment consumption energy, the controller determines whether to turn on the COD heater before the vehicle enters the downhill road based on a comparison between values obtained by subtracting the sum of the rechargeable energy and the auxiliary equipment consumption energy from COD consumption energy consumable by the COD heater and the regenerative power energy while the vehicle travels on the downhill road.

8. The fuel cell system according to claim 7, wherein when the COD consumption energy is less than a value obtained by subtracting the sum of the rechargeable energy and the auxiliary equipment consumption energy from the regenerative power energy, the controller controls the COD heater to be turned on before the vehicle enters the downhill road.

9. The fuel cell system according to claim 8, wherein the controller controls the COD heater to consume COD pre-consumption energy, which is a value obtained by subtracting a sum of the rechargeable energy, the auxiliary equipment consumption energy, and the COD consumption energy from the regenerative power energy, before the vehicle enters the downhill road.

10. The fuel cell system according to claim 9, wherein the controller controls the COD heater to be turned on at a time that precedes a time when the vehicle is expected to enter the downhill road by a preceding time for COD operating obtained by dividing the COD pre-consumption energy by a maximum output of the COD heater.

11. The fuel cell system according to claim 5, wherein after the vehicle enters the downhill road, the controller compares a regenerative power output with a maximum output of the COD heater to determine an ON/OFF time of the COD heater such that the state of charge of the battery does not reach a limit.

12. The fuel cell system according to claim 11, wherein when the COD heater is turned on and the regenerative power output exceeds the maximum output of the COD heater before the vehicle enters the downhill road, the controller controls the COD heater to be operated at a maximum output.

13. The fuel cell system according to claim 11, wherein when the COD heater is turned on and the regenerative power output is less than or equal to the maximum output of the COD heater before the vehicle enters the downhill road, the controller controls the COD heater to be turned off.

14. The fuel cell system according to claim 11, wherein when the COD heater is turned off and the regenerative power output exceeds the maximum output of the COD heater before the vehicle enters the downhill road, the controller controls the COD heater to be turned on.

15. The fuel cell system according to claim 11, wherein when the COD heater is turned off and the regenerative power output is less than or equal to the maximum output of the COD heater before the vehicle enters the downhill road, the controller controls the COD heater to be turned off.

16. The fuel cell system according to claim 15, wherein when the state of charge of the battery reaches the limit by regenerative braking of the vehicle, the controller controls the COD heater such that its output is equal to the regenerative power output.

17. The fuel cell system according to claim 11, wherein the controller controls the COD heater to be turned off when the vehicle exits the downhill road.

18. The fuel cell system according to claim 1, further comprising a heater core disposed between the COD heater and the valve, a PTC heater for vehicle interior heating, and an air conditioning controller configured to control the PTC heater,
wherein when an inlet temperature of the fuel cell stack is less than a required temperature of the heater core, the air conditioning controller transmits a command to turn on the COD heater to the controller.

19. The fuel cell system according to claim 18, wherein when an inlet temperature of the heater core is less than the required temperature of the heater core after the COD heater is turned on, the air conditioning controller transmits a command to increase an output of the COD heater to the controller.

20. The fuel cell system according to claim 19, wherein:
when the inlet temperature of the fuel cell stack is equal to or higher than the required temperature of the heater core, and when the inlet temperature of the heater core is equal to or higher than the required temperature of the heater core after the COD heater is turned on, the air conditioning controller controls an output of the PTC heater by a value obtained by subtracting an amount of heat supplied by the heater core from a required amount of heating; and
the amount of heat supplied by the heater core is calculated based on the inlet temperature of the heater core, the inlet temperature of the fuel cell stack, and heat transfer efficiency of the heater core.
